(19) United States
(12) Patent Application Publication
(10) Pub. No.: US 2016/0139533 A1
(43) Pub. Date: May 19, 2016

(54) LIGHT SCANNING APPARATUS

(71) Applicant: CANON KABUSHIKI KAISHA, Tokyo (JP)

(72) Inventor: Haruhiko Nakatsu, Moriya-shi (JP)

(21) Appl. No.: 14/934,978

(22) Filed: Nov. 6, 2015

(30) Foreign Application Priority Data
Nov. 18, 2014 (JP) 2014-233368

(51) Int. Cl. G03G 15/043; G02B 27/00; G02B 26/12

(52) U.S. Cl. CPC G03G 15/043; G02B 26/123; G02B 27/0006

(57) ABSTRACT

A light scanning apparatus, including: an optical housing, to which a light source is mounted, configured to hold a deflecting unit and an optical unit therein; a cover member configured to cover the optical housing; a seal member configured to seal between the optical housing and the cover member; a screw configured to fasten the cover member to the optical housing; and a shoulder screw configured to fasten the cover member to the optical housing, wherein the screw fastens the cover member to the optical housing in a first disposition portion on which the deflecting unit is disposed with respect to an opening portion through which the light beam passes, the shoulder screw fastens the cover member to the optical housing in a second disposition portion opposite to the first disposition portion, and the shoulder screw is provided on an outer side with respect to the seal member.

### BACKGROUND OF THE INVENTION

1. Field of the Invention

The present invention relates to a light scanning apparatus including a screw and a shoulder screw each configured to fasten a cover member to an optical housing.

2. Description of the Related Art

Light scanning apparatus are used in image forming apparatus such as a laser beam printer and a digital copying machine. The light scanning apparatus each include an optical housing configured to accommodate optical elements such as a mirror and a lens, and a cover member configured to close the optical housing. In order to prevent stains on the optical elements due to dust entering the light scanning apparatus from an outside thereof, there is proposed a configuration in which a seal member is disposed between the optical housing and the cover member over an entire periphery of the light scanning apparatus (Japanese Patent Application Laid-Open No. 2010-066431). The cover member is fastened to the optical housing with screws. The screws are disposed on an inner side with respect to the seal member.

When the optical housing and the cover member are made of different materials, a difference is generated in thermal deformation amount due to a difference in linear expansion coefficient, thereby causing warpage in the light scanning apparatus. When the warpage is caused, positional accuracy of the optical elements disposed inside the light scanning apparatus is deteriorated, thereby deteriorating optical performance. As a method of fixing the cover member to the optical housing, there is given a method using shoulder screws in place of some or all of the plurality of screws so that the warpage deformation due to the linear expansion difference is alleviated. The fastening with the screws generates a significantly high thrust force. When fastening is performed through use of a screw of M3 (JIS B 0205 (2001)) with tightening torque of 0.63 N·m, for example, a thrust force of approximately 700 N is generated in consideration of a frictional force and the like as well. The optical housing, the cover member, and the screws are deformed by compression due to the thrust force, thereby substantially eliminating gaps between respective contact surfaces.

On the other hand, when the shoulder screws are used, the contact surfaces of the screws and the cover member are subjected to a reaction force generated by compression of the seal member. When the seal member having a compressive force of 1.5 N/cm² is used in an area of 50 cm², the reaction force at the time of mounting the cover member becomes 75 N. When the cover member is fastened by seven shoulder screws, a force applied to each shoulder screw becomes approximately 10 N without taking the deformation of the cover member and the like into consideration. Therefore, gaps between the shoulder screws and the cover member cannot be sufficiently reduced because of the reaction force of the seal member. Further, when the shoulder screws are used, the optical housing and the cover member are not held in contact with each other, and hence the gap remains between the optical housing and the cover member. Further, holes formed in the cover member generate gaps between shoulder portions of the shoulder screws and inner peripheries of the holes.

Hitherto, toner having a diameter of several micrometers, which is scattered in the image forming apparatus, or lint of several tens of micrometers causes image failure in many cases by adhering to the optical elements such as a lens, a mirror, and a rotary polygon mirror. The toner having a diameter of several micrometers and the lint of several tens of micrometers are less liable to enter the light scanning apparatus through the gaps between the shoulder screws and the cover member when the shoulder screws are used. In recent years, however, among so-called atmospheric aerosol particles, the amount of airborne particulates having a particle diameter of 1 μm or less is increased in the atmosphere. The airborne particulates enter the light scanning apparatus through the gaps between the shoulder screws and the cover member, the gaps between the shoulder portions of the shoulder screws and the inner peripheries of the holes, and the gap between the optical housing and the cover member when the shoulder screws are used. Then, the airborne particulates may stain the optical elements to cause the image failure. In view of the above, in order to prevent the entry of the fine particulates, the optical housing and the cover member are fastened to each other with the screws other than the shoulder screws. In such a case, there is a problem in that the displacement of the optical elements cannot be reduced because of the thermal deformation of the light scanning apparatus.

### SUMMARY OF THE INVENTION

In view of the above, the present invention provides a light scanning apparatus which reduces displacement of optical elements due to thermal deformation of the light scanning apparatus, and maintains dust-proof performance of the light scanning apparatus.

In order to solve the above-mentioned problem, according to one embodiment of the present invention, there is provided a light scanning apparatus, including: a light source configured to emit a light beam; a deflecting unit configured to deflect the light beam emitted from the light source so that the light beam scans a surface of a photosensitive member; an optical unit configured to form an image of the light beam on the surface of the photosensitive member; an optical housing, to which the light source is mounted, configured to hold the deflecting unit and the optical unit in an inside of the optical housing; a cover member configured to cover the optical housing; a seal member configured to seal between the optical housing and the cover member; a screw configured to fasten the cover member to the optical housing so that the cover member is immovable relative to the optical housing; and a shoulder screw configured to fasten the cover member to the optical housing so that a relative movement between the optical housing and the cover member is allowed when the light scanning apparatus is thermally deformed, wherein one of the optical housing and the cover member is provided with an opening portion through which the light beam deflected by the deflecting unit passes toward the photosensitive member, wherein the screw fastens the cover member to the optical housing in a first disposition portion of the optical housing which is located on a side on which the deflecting unit is disposed with respect to the opening portion, wherein the shoulder screw fastens the cover member to the optical housing in a second disposition portion of the optical housing which is located on a side opposite to the side on which the deflecting unit is disposed with respect to the opening portion, and wherein the shoulder screw is provided on an outer side with respect to the seal member.

Further features of the present invention will become apparent from the following description of exemplary embodiments with reference to the attached drawings.

### BRIEF DESCRIPTION OF THE DRAWINGS

FIG. 1 is a schematic sectional view of a light scanning apparatus according to a first embodiment.

FIG. 2 is a schematic perspective view of the light scanning apparatus according to the first embodiment.

FIG. 3 is a bottom view of a cover member according to the first embodiment.

FIG. 4 is a perspective view of a state before an optical housing and the cover member are connected according to the first embodiment.

FIG. 5 is a perspective view of a second disposition portion before the connecting.

FIG. 6 is a sectional view of a screw and a shoulder screw in a connecting state.

FIG. 7 is a sectional view of the screw and the shoulder screw in another connecting state.

FIG. 8 is a schematic sectional view of a light scanning apparatus according to a second embodiment.

FIG. 9 is a schematic perspective view of the light scanning apparatus according to the second embodiment.

FIG. 10 is a bottom view of a cover member according to the second embodiment.

FIG. 11 is a perspective view of a state before an optical housing and the cover member are connected according to the second embodiment.

FIG. 12 is a sectional view of an image forming apparatus.

### DESCRIPTION OF THE EMBODIMENTS

Now, referring to the drawings, exemplary embodiments of the present invention will be described.

### First Embodiment

### Image Forming Apparatus

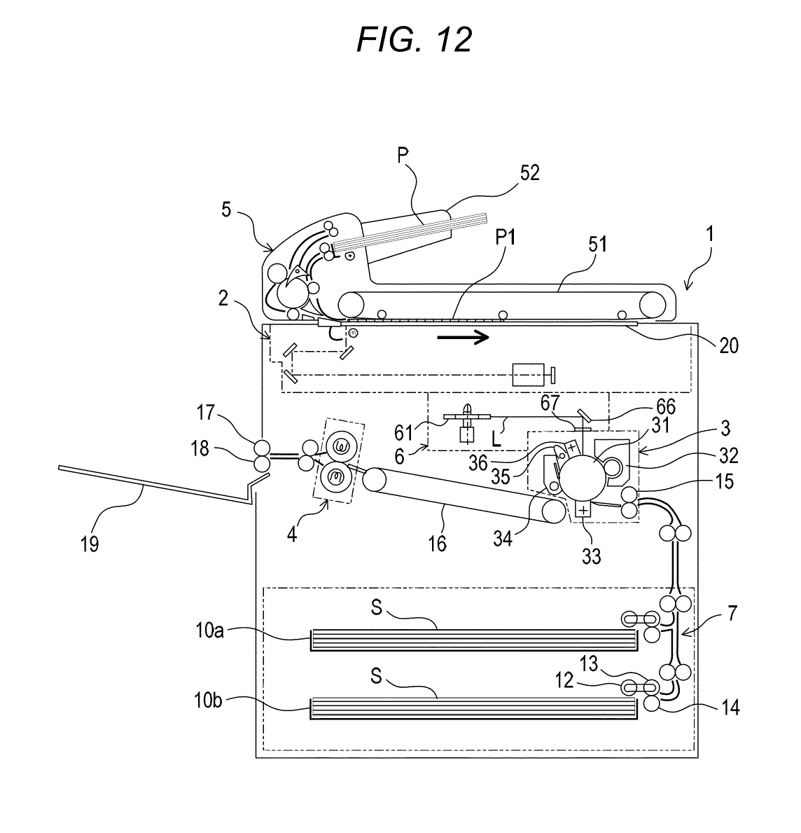

FIG. 12 is a sectional view of an image forming apparatus 1. The image forming apparatus 1 according to the embodiment is a digital copying machine configured to form an image on a recording medium S through use of an electrophotographic image forming process. However, the image forming apparatus 1 may be, for example, an analog copying machine, an electrophotographic printer (such as a color laser beam printer), a multifunction peripheral (MFP), a facsimile machine, a printer, or a word processor. The image forming apparatus 1 according to the embodiment is a monochrome image forming apparatus, but the image forming apparatus 1 may be a color image forming apparatus. The image forming apparatus 1 includes an image reading portion (reading optical system) 2, an image forming portion 3, a fixing device 4, an original conveyance portion 5, a light scanning apparatus 6, and a recording medium conveyance portion 7.

The original conveyance portion 5 includes an original tray 52 on which an original P is stacked, and an original conveyance unit 51 configured to convey the original from the original tray 52 onto an original glass plate 20. The original conveyance portion 5 conveys the original P on the original tray 52 onto the original glass plate 20. An original P1, which is placed on the original glass plate 20, is read by the image reading portion 2 in response to an instruction signal issued from a copy-start command portion (not shown). An image of the original P1 is converted into an image signal by the image reading portion 2. The image signal is input to a digital processing portion (not shown). The digital processing portion converts the image signal into digital data, and performs required data processing on the digital data. The processed digital data is output, as image data, to a video conversion portion (not shown) from the digital processing portion. The video conversion portion converts the image data into a video signal, and outputs the video signal to the light scanning apparatus 6. The light scanning apparatus 6 outputs laser light (hereinafter referred to as a light beam) L based on the video signal.

The light scanning apparatus 6 includes a deflecting unit (deflector) 61, a light source unit (light source) 62, and optical elements. The light scanning apparatus 6 outputs the light beam L toward the deflecting unit 61 based on the video signal output from the video conversion portion. The light beam L is deflected by the deflecting unit 61 so as to scan a photosensitive drum (photosensitive member) 31. The light beam L repeatedly scans the rotating photosensitive drum 31, to thereby form a latent image on the photosensitive drum 31. A developing device 32 causes developer (toner) to adhere to the latent image on the photosensitive drum 31, to thereby form a toner image.

Meanwhile, transfer materials (recording media) S inside a sheet feeding cassette 10a or 10b, which is disposed in a lower portion of the image forming apparatus 1, are fed one by one by a pickup roller 12. The transfer material S is fed to registration rollers 15 by feed rollers 13 and 14. The registration rollers 15 convey the transfer material S to a transfer portion between the photosensitive drum 31 and a transfer charger 33 in synchronization with the toner image on the photosensitive drum 31. In the transfer portion, the toner image on the photosensitive drum 31 is transferred onto the transfer material S by the transfer charger 33. After that, the transfer material S is conveyed to the fixing device 4 by a conveyance portion 16. The fixing device 4 heats and pressurizes the transfer material S so that the toner image is fixed onto the transfer material S. The transfer material S having the image formed thereon is delivered onto a delivery tray 19 by delivery rollers 17 and 18. Further, a subsequent transfer material S is similarly conveyed with a given interval secured from the leading transfer material S, and is then delivered onto the delivery tray 19 after being subjected to an image forming process.

The toner remaining on the photosensitive drum 31 is removed by a cleaner 34. Further, the charge on the photosensitive drum 31 is eliminated by a charge eliminator 35. After the photosensitive drum 31 is charged by a charger 36, a latent image is formed again on the photosensitive drum 31 by the light scanning apparatus 6. The light scanning apparatus 6 used in the image forming apparatus 1, which performs the image forming process as described above, will be described below.

Light Scanning Apparatus

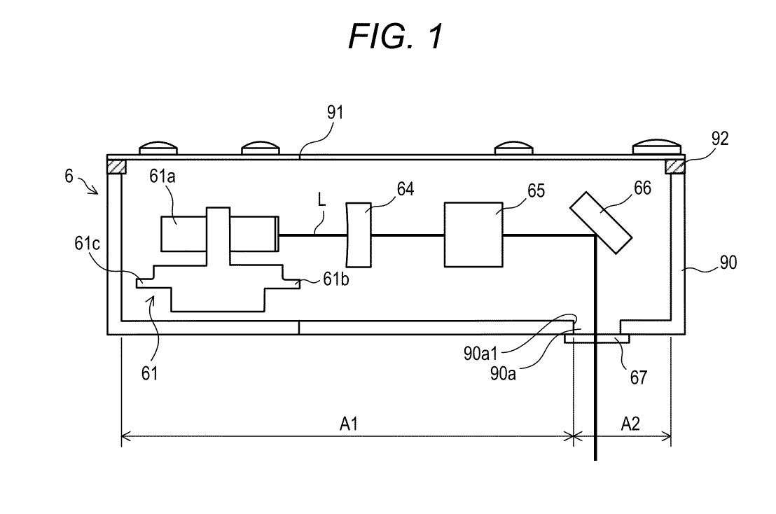

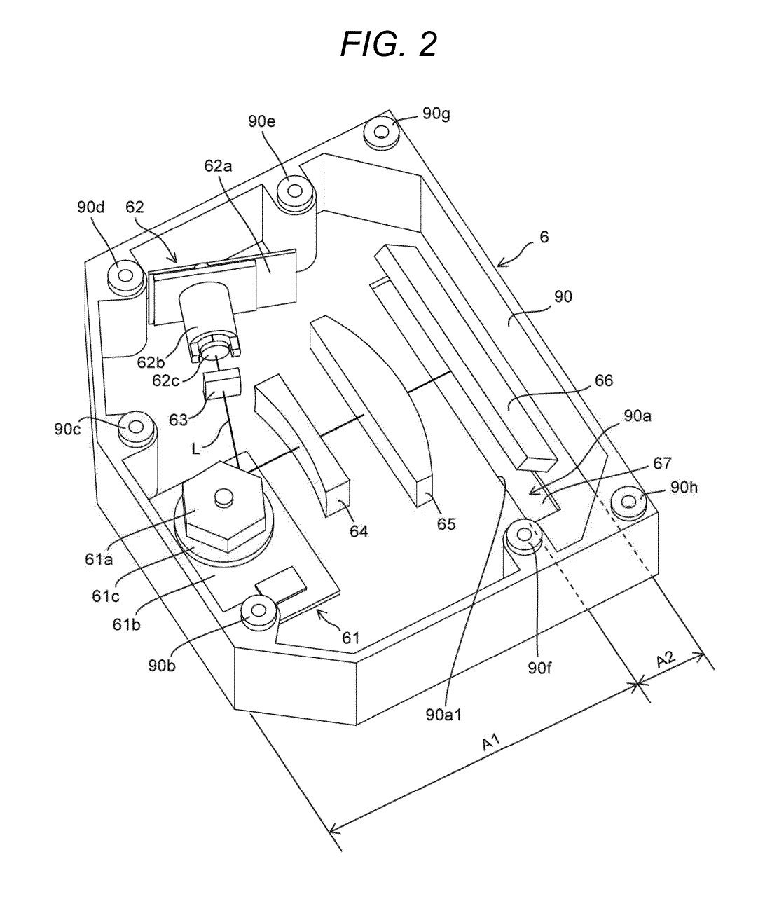

FIG. 1 is a schematic sectional view of the light scanning apparatus 6 according to the first embodiment. FIG. 2 is a schematic perspective view of the light scanning apparatus 6 according to the first embodiment. The light scanning apparatus 6 includes an optical housing (casing) 90 configured to accommodate the optical elements, and a cover member 91 configured to close the optical housing 90. The optical housing 90 is formed of a resin material. The light source unit 62 includes a semiconductor laser (not shown), an electric drive circuit board 62a for the semiconductor laser, a collimator lens barrel 62b, and a collimator lens 62c. The light beam L, which is emitted from the semiconductor laser, is converted into a collimated light beam L by the collimator lens 62c. A cylinder lens 63 has refractive power in a sub-scanning direction. The deflecting unit 61 deflects the light beam L so that the light beam L scans a surface of the photosensitive drum 31. The deflection of the light beam L is carried out through rotation of a rotary polygon mirror (deflecting member) 61a. The rotary polygon mirror 61a is rotated by a motor 61c mounted on a drive circuit board 61b. The drive circuit board 61b has mounted thereon a motor drive circuit configured to drive the motor 61c. A toric lens 64 and a cylinder lens 65 form an image of the light beam L on the photosensitive drum 31 at a predetermined spot diameter. The toric lens 64, the cylinder lens 65, and a reflection mirror 66 are optical elements constructing a scanning optical system (optical unit). The optical housing 90 integrally retains the light source unit 62, the deflecting unit 61, and the scanning optical system.

Optical Housing

The optical housing 90 has an opening portion 90a formed therein, through which the light beam L deflected by the rotary polygon mirror 61a is caused to pass toward the photosensitive drum 31. The opening portion 90a has a dust-proof glass 67 fixed thereto with an adhesive or the like, for preventing outside airborne particulates from entering the light scanning apparatus 6. In the embodiment, the opening portion 90a is formed in the optical housing 90, but may be formed in the cover member 91. With an end portion 90a1 of the opening portion 90a on the side of the deflecting unit 61 being a boundary, a part of the optical housing 90 located on a side on which the deflecting unit is disposed is hereinafter referred to as a first disposition portion A1. A part of the optical housing 90 located on a side opposite to the side on which the deflecting unit 61 is disposed is referred to as a second disposition portion A2.

The light source unit 62, the cylinder lens 63, the deflecting unit 61, the toric lens 64, and the cylinder lens 65 are supported by support portions disposed on a bottom surface or side walls of the first disposition portion A1 of the optical housing 90. The reflection mirror 66 is supported by a support portion of the optical housing 90 at both end portions of the reflection mirror 66 in a longitudinal direction. One end portion of the reflection mirror 66 in the longitudinal direction is supported at two points, and another end portion thereof in the longitudinal direction is supported at one point. At least one point out of the three points is supported by a support portion disposed on a bottom surface or side walls of the second disposition portion A2 of the optical housing 90. The optical housing 90 has bearing surfaces 90b, 90c, 90d, 90e, 90f, 90g, and 90h formed therein, for allowing the cover member 91 to be fastened to the optical housing 90 with screws.

Cover Member

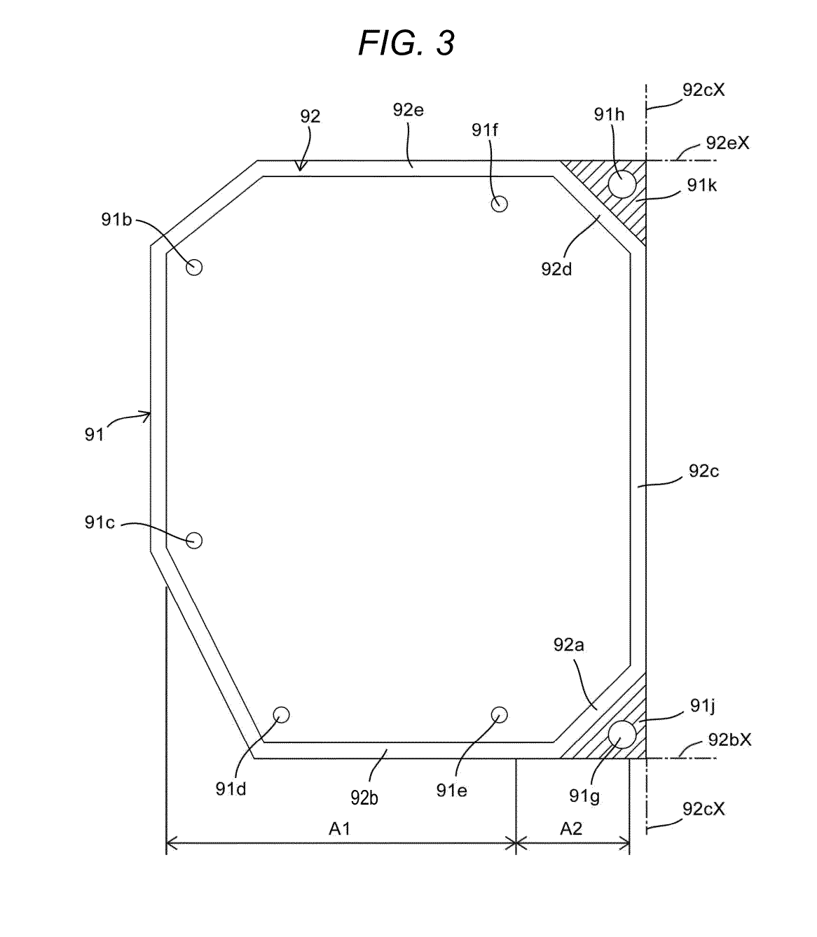

FIG. 3 is a bottom view of the cover member 91 according to the first embodiment. FIG. 3 is a view of the cover member 91 when viewed from a lower side of FIG. 1. The cover member 91 is formed of a metal flat plate. The cover member 91 has holes 91b, 91c, 91d, 91e, 91f, 91g, and 91h formed therein, for allowing the cover member 91 to be screw-fastened to the optical housing 90. The holes 91b to 91h correspond to the bearing surfaces 90b to 90h illustrated in FIG. 2, respectively.

Seal Member

A seal member 92 is formed of urethane foam or low-hardness rubber. Hitherto, at least one elongated seal member is bonded to the cover member 91 in many cases. However, a gap is generated at one or more portions, and hence dust-proofing becomes insufficient. In the embodiment, in order to enhance the dust-proof performance, the endless and continuous seal member 92 formed into a shape illustrated in FIG. 3 is bonded to the cover member 91 with a double-sided adhesive tape. Alternatively, there may be used such a seal member that temporarily-melted synthetic rubber is applied to the cover member 91 along a periphery thereof. In such a case, a material for the seal member is not wasted.

The seal member 92 is disposed between the optical housing 90 and the cover member 91 to tightly close the gap between the optical housing 90 and the cover member 91, thereby sealing the light scanning apparatus 6. The seal member 92 is compressed between the optical housing 90 and the cover member 91, thereby sealing the gap between the optical housing 90 and the cover member 91. The seal member 92 is disposed along the periphery of the cover member 91. The seal member 92 is disposed on an outer side with respect to the holes 91b, 91c, 91d, 91e, and 91f in a part of the cover member 91 covering the first disposition portion A1 of the optical housing 90. That is, the holes 91b, 91c, 91d, 91e, and 91f are surrounded by the seal member 92. The seal member 92 is disposed on an inner side with respect to the holes 91g and 91h in a part of the cover member 91 covering the second disposition portion A2 of the optical housing 90. That is, the holes 91g and 91h are not surrounded by the seal member 92.

The hole 91g is formed in a flat surface portion (hatched portion) 91j of the cover member 91 which is surrounded by a portion 92a of the seal member 92 disposed on the inner side with respect to the hole 91g, an extension line 92bX of a portion 92b contiguous with the portion 92a, and an extension line 92cX of a portion 92c contiguous with the portion 92a. The hole 91h is formed in a flat surface portion (hatched portion) 91k of the cover member 91 which is surrounded by a portion 92d of the seal member 92 disposed on the inner side with respect to the hole 91h, an extension line 92eX of a portion 92e contiguous with the portion 92d, and the extension line 92cX of the portion 92c contiguous with the portion 92d. The flat surface portions 91j and 91k are formed in parts of the cover member 91 corresponding to corner portions of the optical housing 90 in the vicinity of both the end portions of the reflection mirror 66 in the longitudinal direction.

Fastening Member

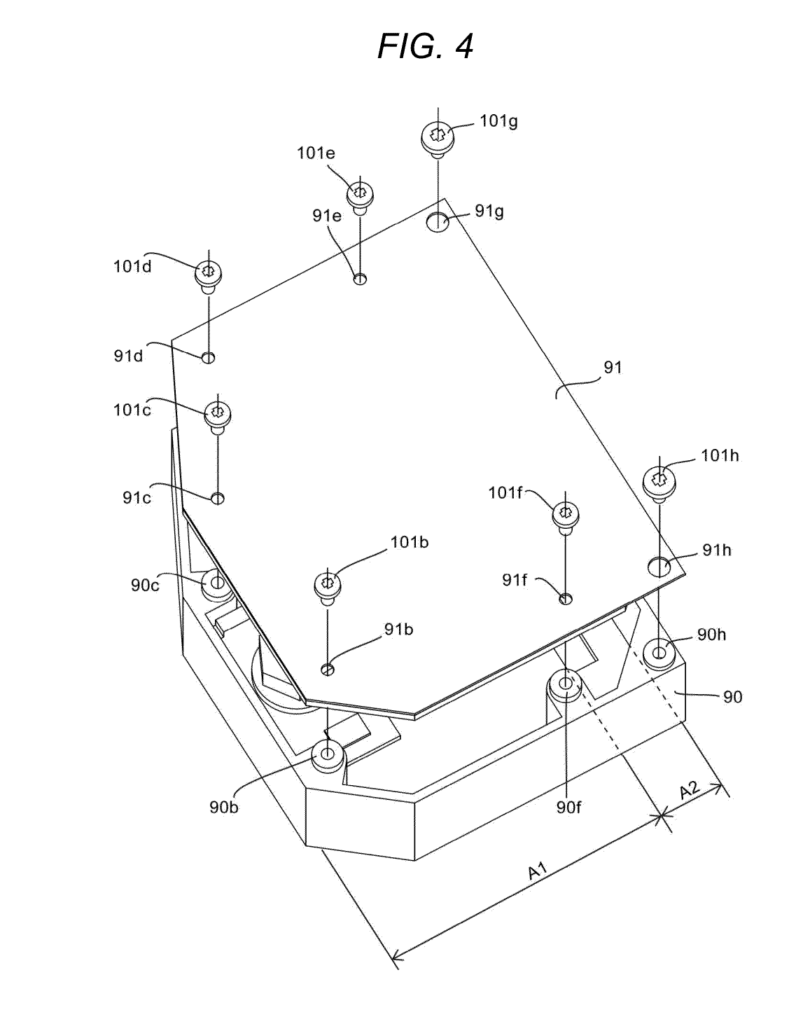

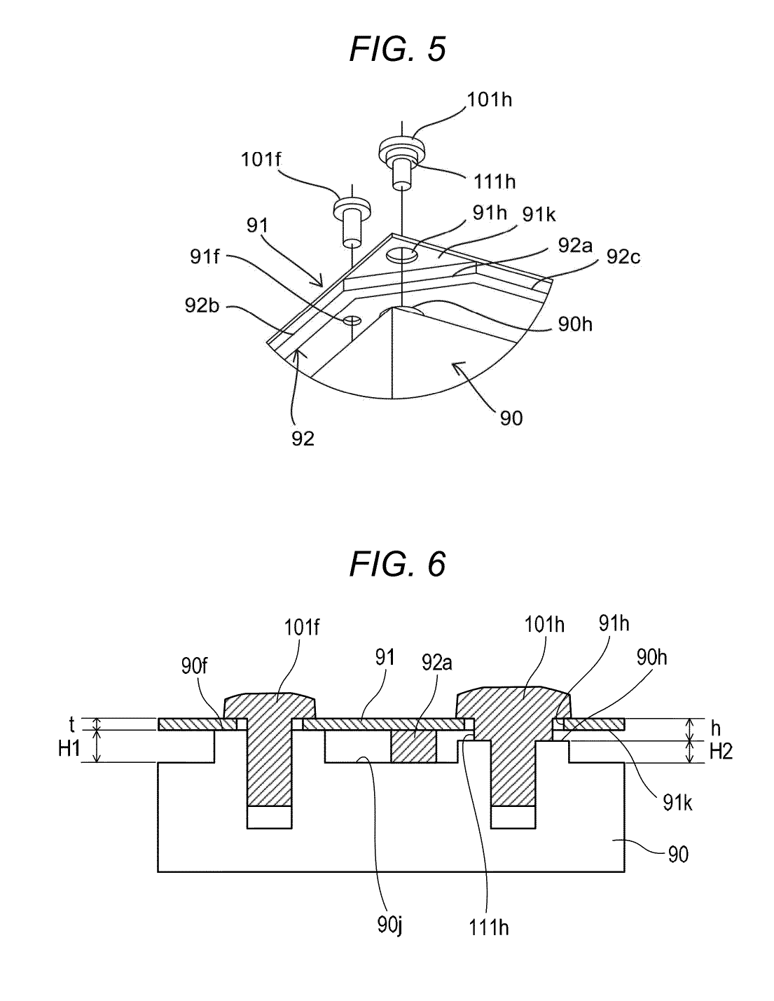

FIG. 4 is a perspective view of a state before the optical housing 90 and the cover member 91 are connected according to the first embodiment. FIG. 5 is a perspective view of the second disposition portion A2 before the connecting. FIG. 5 is a view of the second disposition portion A2 before the optical housing 90 and the cover member 91 are connected when viewed from the optical housing 90. After the cover member 91 is placed on the optical housing 90, the cover member 91 is fastened to the first disposition portion A1 of the optical housing 90 with screws (first fastening members) 101b, 101c, 101d, 101e, and 101f. The screws 101b, 101c, 101d, 101e, and 101f rigidly fasten (firmly fix) the cover member 91 to the optical housing 90 in the first disposition portion A1. In the embodiment, the screws 101b, 101c, 101d, 101e, and 101f fix the cover member 91 to the optical housing 90 in the first disposition portion A1 so that the cover member 91 is immovable relative to the optical housing 90.

The cover member 91 is fastened to the second disposition portion A2 of the optical housing 90 with shoulder screws (second fastening members) 101g and 101h. The shoulder screws 101g and 101h are provided in the vicinity of both end portions of the opening portion 90a in a longitudinal direction. Unthreaded cylindrical portions (hereinafter referred to as shoulder portions) 111g (not shown) and 111h of the shoulder screws 101g and 101h have outer diameters smaller than inner diameters of the holes 91g and 91h. The shoulder screws 101g and 101h position the optical housing 90 and the cover member 91 in an abutment direction of the seal member 92, and fasten the optical housing 90 and the cover member 91 so that the optical housing 90 and the cover member 91 are relatively movable in a direction perpendicular to the abutment direction. The abutment direction of the seal member 92 corresponds to a fastening direction of the shoulder screws 101g and 101h, that is, a compressing direction of the seal member 92. The shoulder screws 101g and 101h fasten (fix) the cover member 91 to the optical housing 90 in the second disposition portion A2 to such an extent as to allow deformation of the cover member 91 due to thermal deformation thereof. The shoulder screws 101g and 101h, which are disposed on the outer side with respect to the seal member 92, are disposed in the vicinity of the seal member 92 in order to maintain a stable compression amount of the seal member 92.

The outer diameters of the shoulder portions 111g (not shown) and 111h of the shoulder screws 101g and 101h are smaller than the inner diameters of the holes 91g and 91h, and hence gaps are formed between the shoulder portions 111g (not shown) and 111h and the holes 91g and 91h. When the light scanning apparatus 6 is thermally deformed, the optical housing 90 and the cover member 91 are relatively movable by an amount corresponding to the gaps. With this, warpage of the light scanning apparatus 6 is prevented, thereby being capable of reducing displacement of the optical elements disposed inside the light scanning apparatus 6. However, fine powder dust outside the light scanning apparatus 6 may enter the light scanning apparatus 6 through the gaps between the shoulder portions 111g (not shown) and 111h of the shoulder screws 101g and 101h and the holes 91g and 91h. In view of the above, the shoulder screws 101g and 101h are disposed on the outer side with respect to the seal member 92.

FIG. 6 is a sectional view of the screw 101f and the shoulder screw 101h in a connecting state. Referring to FIG. 6, dimensions of each component in the connecting state will be described. Although dimensions of a fastening portion of each of the screw 101f and the shoulder screw 101h will be described, a fastening portion of each of the other screws 101b to 101e and the other shoulder screw 101g has similar dimensions. The cover member 91 is formed of a flat plate. In the fastening portion of the screw 101f, a height from a reference surface 90j to the bearing surface 90f of the optical housing 90 is represented by H1. In the embodiment, the reference surface 90j of the optical housing 90 is a surface of the optical housing 90 held in contact with the seal member 92. A thickness of the cover member 91 is represented by “t”. In the fastening portion of the shoulder screw 101h, a height from the reference surface 90j to the bearing surface 90h of the optical housing 90 is represented by H2. A length beneath the head of the shoulder screw 101h (length of the shoulder portion 111h) is represented by “h”. When a condition of H1+t=H2+h is satisfied, the deformation of the cover member 91 is prevented, thereby being capable of stabilizing the compression amount of the seal member 92. With this, the dust-proof performance of the light scanning apparatus 6 is secured.

Further, the length “h” of the shoulder portion 111h of the shoulder screw 101h is set larger than the thickness “t” of the cover member 91 (h>t), thereby allowing slippage between the bearing surface 90h and the cover member 91 and between the shoulder screw 101h and the cover member 91. With this, the deformation of the light scanning apparatus 6 can be suppressed.

Modification of Cover Member

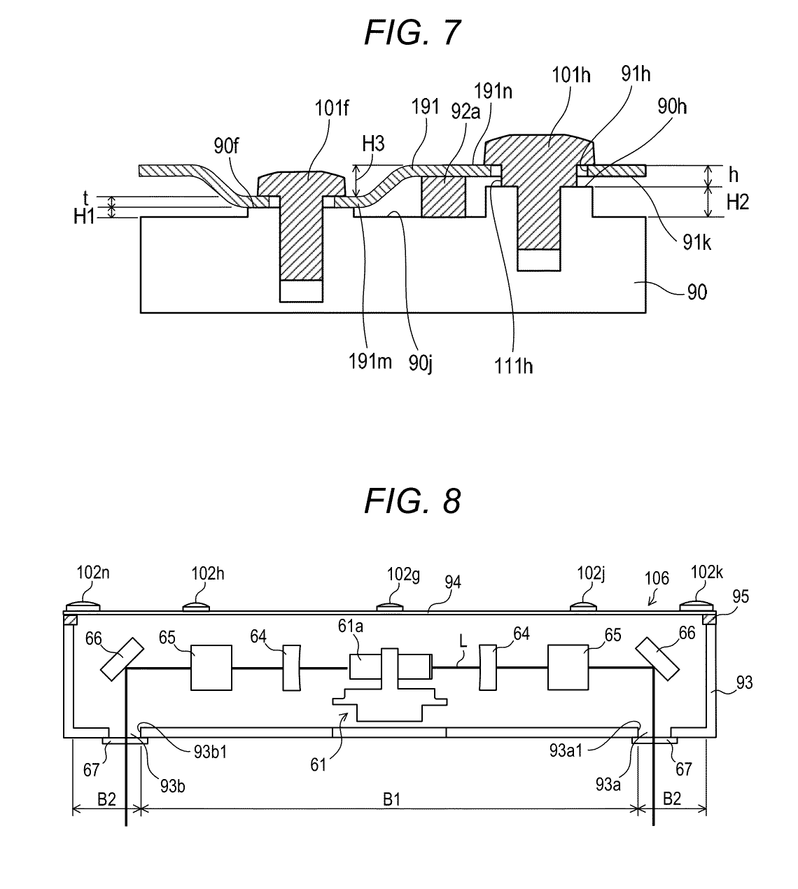

FIG. 7 is a sectional view of the screw 101f and the shoulder screw 101h in another connecting state. Referring to FIG. 7, dimensions of each component in the another connecting state will be described. A portion 191m of a cover member 191 to be fastened by the screw is formed by drawing. A step between the portion 191m to be fastened by the screw and a portion 191n to be fastened by the shoulder screw is represented by H3. In the cover member 191, parts similar to the parts of the cover member 91 are denoted by similar reference symbols to omit description thereof. Similarly to FIG. 6, in the portion 191m to be fastened by the screw, a height from the reference surface 90j to the bearing surface 90f of the optical housing 90 is represented by H1. A thickness of the cover member 191 is represented by “t”. In the portion 191n to be fastened by the shoulder screw, a height from the reference surface 90j to the bearing surface 90h of the optical housing 90 is represented by H2. A length of the shoulder portion 111h of the shoulder screw 101h is represented by “h”. When a condition of H1+t+H3=H2+h is satisfied, deformation of the cover member 191 is prevented, thereby being capable of stabilizing the compression amount of the seal member 92. With this, the dust-proof performance of the light scanning apparatus 6 is secured.

Further, the length “h” of the shoulder portion 111h of the shoulder screw 101h is set larger than the thickness “t” of the cover member 91 (h>t), thereby allowing slippage between the bearing surface 90h and the cover member 191 and between the shoulder screw 101h and the cover member 191. With this, the deformation of the light scanning apparatus 6 is suppressed.

The portion to be fastened by the screw may be a combination of a flat portion to be fastened by the screw as illustrated in FIG. 6 and the portion 191m to be fastened by the screw, which is formed by drawing, as illustrated in FIG. 7. Further, a step may be formed by drawing or the like at the portion to be fastened by the shoulder screw in the cover member 91 or the cover member 191.

According to the embodiment, it is possible to reduce the displacement of the optical elements due to the thermal deformation of the light scanning apparatus, and to maintain the dust-proof performance of the light scanning apparatus.

### Second Embodiment

Now, a second embodiment of the present invention will be described. In the second embodiment, components similar to the components of the first embodiment are denoted by similar reference symbols to omit description thereof. An image forming apparatus according to the second embodiment (not shown) includes a light scanning apparatus 106 configured to scan a plurality of photosensitive drums (not shown) with a plurality of light beams L.

Light Scanning Apparatus

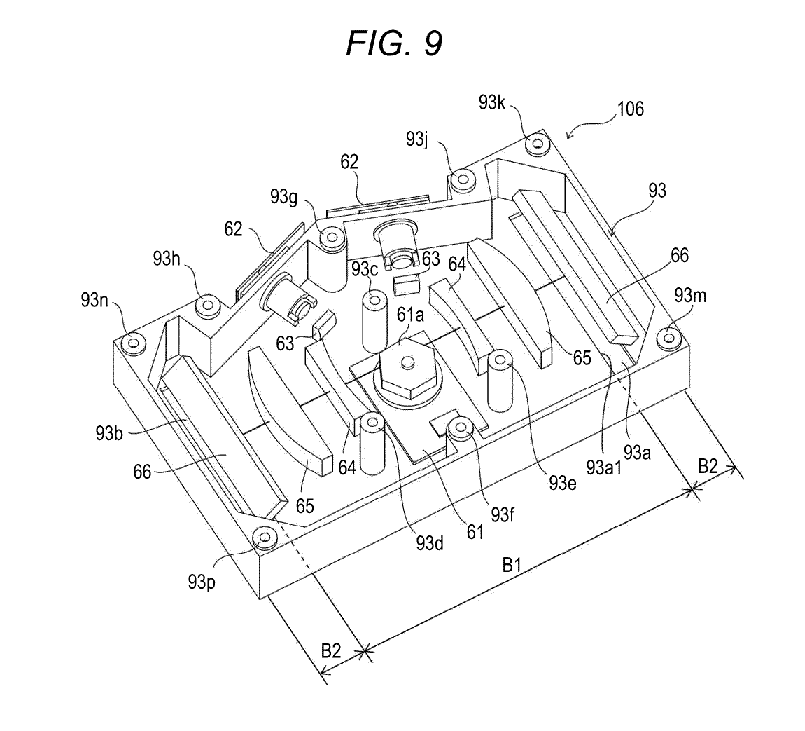

FIG. 8 is a schematic sectional view of the light scanning apparatus 106 according to the second embodiment. FIG. 9 is a schematic perspective view of the light scanning apparatus 106 according to the second embodiment. The light scanning apparatus 106 includes a plurality of light source units (light sources) 62. In the embodiment, the light scanning apparatus 106 includes two light source units 62. In the light scanning apparatus 106, the scanning optical systems (optical units) are disposed on both sides of the deflecting unit 61 so that two photosensitive drums are exposed to light through use of one deflecting unit 61. In FIG. 8 and FIG. 9, components having similar functions to the components illustrated in FIG. 1 and FIG. 2 are denoted by similar reference symbols to omit description thereof.

Optical Housing

An optical housing 93 is formed of a resin material. The optical housing 93 has a plurality of opening portions 93a and 93b formed therein, through which the light beams L deflected by the rotary polygon mirror 61a are caused to pass toward the photosensitive drums. The opening portions 93a and 93b each have the dust-proof glass 67 fixed thereto with an adhesive or the like, for preventing outside airborne particulates from entering the light scanning apparatus 106. In the embodiment, the opening portions 93a and 93b are formed in the optical housing 93, but may be formed in a cover member 94. With end portions 93a1 and 93b1 of the opening portions 93a and 93b on the side of the deflecting unit 61 being boundaries, a part of the optical housing 93 located on a side on which the deflecting unit 61 is disposed is hereinafter referred to as a first disposition portion B1, and parts of the optical housing 93 located on both sides of the first disposition portion B1 are hereinafter referred to as second disposition portions B2.

The light source units 62, the cylinder lenses 63, the deflecting unit 61, the toric lenses 64, and the cylinder lenses 65 are supported by support portions disposed on a bottom surface or side walls of the first disposition portion B1 of the optical housing 93. The reflection mirrors 66 are each supported by a support portion of the optical housing 93 at both end portions of each of the reflection mirrors 66 in the longitudinal direction. One end portion of each of the reflection mirrors 66 in the longitudinal direction is supported at two points, and another end portion thereof in the longitudinal direction is supported at one point. At least one point out of the three points is supported by a support portion disposed on a bottom surface or side walls of the second disposition portion B2 of the optical housing 93. The optical housing 93 has bearing surfaces 93c, 93d, 93e, 93f, 93g, 93h, 93j, 93k, 93m, 93n, and 93p formed therein, for allowing the cover member 94 to be fastened to the optical housing 93 with screws.

Cover Member

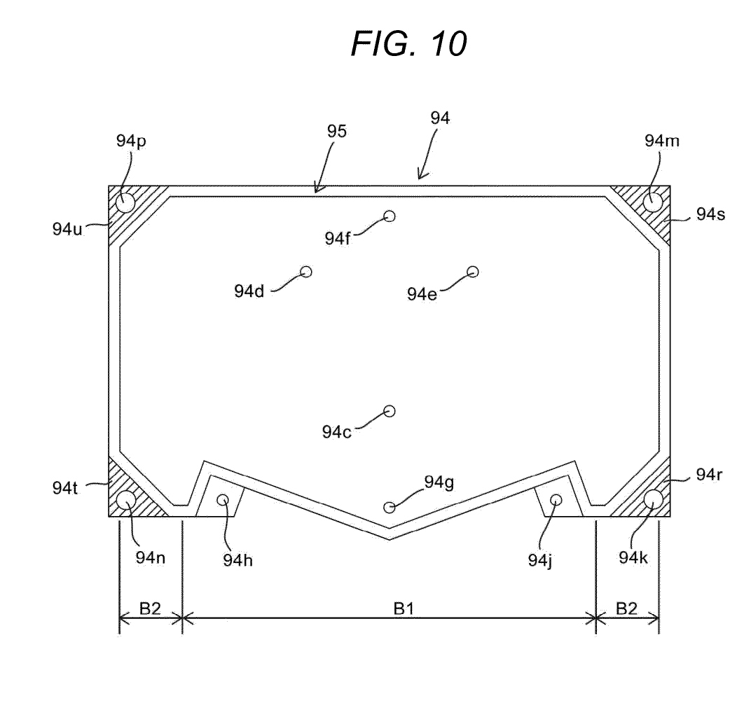

FIG. 10 is a bottom view of the cover member 94 according to the second embodiment. FIG. 10 is a view of the cover member 94 when viewed from a lower side of FIG. 8. The cover member 94 is formed of a metal flat plate. The cover member 94 has holes 94c, 94d, 94e, 94f, 94g, 94h, 94j, 94k, 94m, 94n, and 94p formed therein, for allowing the cover member 94 to be screw-fastened to the optical housing 93. The holes 94c to 94p correspond to the bearing surfaces 93c to 93p illustrated in FIG. 9, respectively.

Seal Member

A seal member 95 is formed of urethane foam or low-hardness rubber (flexible member). In the embodiment, in order to enhance the dust-proof performance, the endless and continuous seal member 95 formed into a shape illustrated in FIG. 10 is bonded to the cover member 94 with a double-sided adhesive tape. Alternatively, there may be used such a seal member that temporarily-melted synthetic rubber is applied to the cover member 94 along a periphery thereof. In such a case, a material for the seal member is not wasted.

The seal member 95 is compressed between the optical housing 93 and the cover member 94, thereby sealing a gap between the optical housing 93 and the cover member 94. The seal member 95 is disposed along the periphery of the cover member 94. The seal member 95 is disposed on an outer side with respect to the holes 94c, 94d, and 94e surrounding the deflecting unit 61 in a part of the cover member 94 covering the first disposition portion B1 of the optical housing 93. That is, the holes 94c, 94d, and 94e are surrounded by the seal member 95. The seal member 95 is disposed on an inner side with respect to the holes 94k, 94m, 94n, and 94p in a part of the cover member 94 covering the second disposition portions B2 of the optical housing 93. That is, the holes 94k, 94m, 94n, and 94p are not surrounded by the seal member 95.

In the first disposition portion B1, of the holes through which the screws configured to fasten the cover member 94 to the optical housing 93 are inserted, the holes 94f, 94g, 94h, and 94j that do not surround the deflecting unit 61 may be formed on the inner side or the outer side with respect to the seal member 95. In the second disposition portions B2, the holes 94k, 94m, 94n, and 94p, through which the screws configured to fasten the cover member 94 to the optical housing 93 are inserted, are formed in flat surface portions (hatched portions) 94r, 94s, 94t, and 94u similar to the flat surface portions 91j and 91k illustrated in FIG. 3. The flat surface portions 94r, 94s, 94t, and 94u are formed in parts of the cover member 94 corresponding to corner portions of the optical housing in the vicinity of both the end portions of the reflection mirrors 66 in the longitudinal direction.

Fastening Member

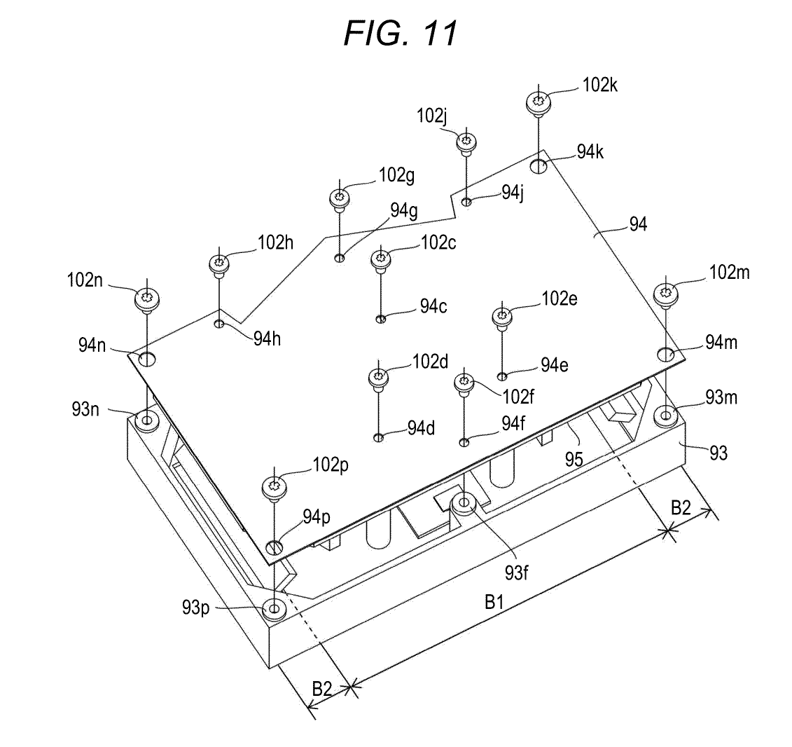

FIG. 11 is a perspective view of a state before the optical housing 93 and the cover member 94 are connected according to the second embodiment. After the cover member 94 is placed on the optical housing 93, the cover member 94 is fastened to the optical housing 93 in at least three positions surrounding the deflecting unit 61 on the first disposition portion B1 of the optical housing 93 with screws (first fastening members) 102c, 102d, and 102e. The screws 102c, 102d, and 102e rigidly fasten (firmly fix) the cover member 94 to the optical housing 93 in the first disposition portion B1. In the embodiment, the screws 102c, 102d, and 102e fix the cover member 94 to the optical housing 93 in the first disposition portion B1 so that the cover member 94 is immovable relative to the optical housing 93.

The cover member 94 is fastened to the second disposition portions B2 of the optical housing 93 with shoulder screws (second fastening members) 102k, 102m, 102n, and 102p. The shoulder screws 102k, 102m, 102n, and 102p are provided in the vicinity of both end portions of the opening portions 93a and 93b in a longitudinal direction. The shoulder screws 102k, 102m, 102n, and 102p position the optical housing 93 and the cover member 94 in an abutment direction of the seal member 95, and fasten the optical housing 93 and the cover member 94 so that the optical housing 93 and the cover member 94 are relatively movable in a direction perpendicular to the abutment direction. The abutment direction of the seal member 95 corresponds to a fastening direction of the shoulder screws 102k, 102m, 102n, and 102p, that is, a compressing direction of the seal member 95. The shoulder screws 102k, 102m, 102n, and 102p fasten (fix) the cover member 94 to the optical housing 93 in the second disposition portions B2 to such an extent as to allow deformation of the cover member 94 due to thermal deformation thereof. The shoulder screws 102k, 102m, 102n, and 102p, which are disposed on the outer side with respect to the seal member 95, are disposed in the vicinity of the seal member 95 in order to maintain a stable compression amount of the seal member 95.

In the first disposition portion B1, the holes 94f and 94g are formed on the inner side with respect to the seal member 95, and hence the optical housing 93 and the cover member 94 are fastened by screws 102f and 102g extending through the holes 94f and 94g. The screws 102f and 102g do not surround the deflecting unit 61, and hence the screws 102f and 102g may be disposed on the outer side with respect to the seal member 95 together with the holes 94f and 94g. When the screws 102f and 102g are disposed on the outer side with respect to the seal member 95, the screws 102f and 102g may be shoulder screws. The optical housing 93 and the cover member 94 are fastened by screws 102h and 102j extending through the holes 94h and 94j. However, in the embodiment, the holes 94h and 94j are formed on the outer side with respect to the seal member 95, and hence the screws 102h and 102j may be shoulder screws.

According to the embodiment, it is possible to reduce the displacement of the optical elements due to the thermal deformation of the light scanning apparatus, and to maintain the dust-proof performance of the light scanning apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-233368, filed Nov. 18, 2014, which is hereby incorporated by reference herein in its entirety.

What is claimed is:

1. A light scanning apparatus, comprising:
a light source configured to emit a light beam;
a deflecting unit configured to deflect the light beam emitted from the light source so that the light beam scans a surface of a photosensitive member;
an optical unit configured to form an image of the light beam on the surface of the photosensitive member;
an optical housing, to which the light source is mounted, configured to hold the deflecting unit and the optical unit in an inside of the optical housing;
a cover member configured to cover the optical housing;
a seal member configured to seal between the optical housing and the cover member;
a screw configured to fasten the cover member to the optical housing so that the cover member is immovable relative to the optical housing; and
a shoulder screw configured to fasten the cover member to the optical housing so that a relative movement between the optical housing and the cover member is allowed when the light scanning apparatus is thermally deformed,
wherein one of the optical housing and the cover member is provided with an opening portion through which the light beam deflected by the deflecting unit passes toward the photosensitive member,
wherein the screw fastens the cover member to the optical housing in a first disposition portion of the optical housing which is located on a side on which the deflecting unit is disposed with respect to the opening portion,
wherein the shoulder screw fastens the cover member to the optical housing in a second disposition portion of the optical housing which is located on a side opposite to the side on which the deflecting unit is disposed with respect to the opening portion, and
wherein the shoulder screw is provided on an outer side with respect to the seal member.

2. The light scanning apparatus according to claim 1, wherein the screw comprises screws configured to fasten the cover member to the optical housing in at least three positions surrounding the deflecting unit on the first disposition portion.

3. The light scanning apparatus according to claim 1, wherein the screw is provided on an inner side with respect to the seal member.

4. The light scanning apparatus according to claim 1, wherein the shoulder screw is provided in a vicinity of an end portion of the opening portion in a longitudinal direction of the opening portion.

5. The light scanning apparatus according to claim 1, wherein the seal member comprises an endless and continuous flexible member.

6. The light scanning apparatus according to claim 1,
wherein the light source comprises a plurality of light sources, and
wherein the opening portion comprises a plurality of opening portions provided in the one of the optical housing and the cover member.

7. An image forming apparatus, comprising:
an image forming portion having a photosensitive member and configured to form an image on a recording medium; and
a light scanning apparatus configured to emit a light beam to the photosensitive member,
the light scanning apparatus including:
a light source configured to emit the light beam;
a deflecting unit configured to deflect the light beam emitted from the light source so that the light beam scans a surface of the photosensitive member;
an optical unit configured to form an image of the light beam on the surface of the photosensitive member;
an optical housing, to which the light source is mounted, configured to hold the deflecting unit and the optical unit in an inside of the optical housing;
a cover member configured to cover the optical housing;
a seal member configured to seal between the optical housing and the cover member;
a screw configured to fasten the cover member to the optical housing so that the cover member is immovable relative to the optical housing; and
a shoulder screw configured to fasten the cover member to the optical housing so that a relative movement between the optical housing and the cover member is allowed when the light scanning apparatus is thermally deformed,
wherein one of the optical housing and the cover member is provided with an opening portion through which the light beam deflected by the deflecting unit passes toward the photosensitive member,
wherein the screw fastens the cover member to the optical housing in a first disposition portion of the optical housing which is located on a side on which the deflecting unit is disposed with respect to the opening portion,
wherein the shoulder screw fastens the cover member to the optical housing in a second disposition portion of the optical housing which is located on a side opposite to the side on which the deflecting unit is disposed with respect to the opening portion, and
wherein the shoulder screw is provided on an outer side with respect to the seal member.

8. The image forming apparatus according to claim 7, wherein the screw comprises screws configured to fasten the cover member to the optical housing in at least three positions surrounding the deflecting unit on the first disposition portion.

9. The image forming apparatus according to claim 7, wherein the screw is provided on an inner side with respect to the seal member.

10. The image forming apparatus according to claim 7, wherein the shoulder screw is provided in a vicinity of an end portion of the opening portion in a longitudinal direction of the opening portion.

11. The image forming apparatus according to claim 7, wherein the seal member comprises an endless and continuous flexible member.

12. The image forming apparatus according to claim 7,
wherein the light source comprises a plurality of light sources, and
wherein the opening portion comprises a plurality of opening portions provided in the one of the optical housing and the cover member.
